(19) United States
(12) Patent Application Publication
(10) Pub. No.: US 2012/0143470 A1
(43) Pub. Date: Jun. 7, 2012

(54) METHOD FOR OPERATING A VARIABLE DISPLACEMENT OIL PUMP

(75) Inventors: Alberto VASSALLO, Torino (IT); Giovanni DAVID, Torino (IT)

(73) Assignee: GM GLOBAL TECHNOLOGY OPERATIONS LLC, Detroit, MI (US)

(21) Appl. No.: 13/308,664

(22) Filed: Dec. 1, 2011

(30) Foreign Application Priority Data
Dec. 6, 2010 (GB) 1020594.6

(51) Int. Cl. F01M 1/16; F01M 1/02; F02D 28/00

(52) U.S. Cl. 701/102

(57) ABSTRACT

A method is provided for operating a variable displacement oil pump of an internal combustion engine, that includes, but is not limited to measuring a value of an engine metal temperature and of preventing the variable displacement oil pump to switch from an high displacement configuration to a low displacement configuration, as long as the measured value is greater than a first threshold value of the engine metal temperature.

### CROSS-REFERENCE TO RELATED APPLICATION

This application claims priority to British Patent Application No. 1020594.6, filed Dec. 6, 2010, which is incorporated herein by reference in its entirety.

### TECHNICAL FIELD

The technical field generally relates to a method for operating a variable displacement oil pump (VDOP) belonging to a lubrication circuit of an internal combustion engine of a motor vehicle, for instance a Diesel engine or a gasoline engine.

### BACKGROUND

It is known that internal combustion engines comprise a lubrication circuit suitable for lubricating the rotating or sliding components of the engine. This lubrication circuit generally comprises an oil pump driven by the engine, which draws a lubricating oil from an oil sump and delivers it under pressure through a main oil gallery that is realized in the cylinder block. The main oil gallery is connected via respective channels with a plurality of exit holes for lubricating crankshaft bearings (main bearings and big-end bearings), camshaft bearings operating the valves, tappets, and the like, from which the lubricating oil finally returns into the oil sump.

In order to reduce polluting emission and fuel consumption, the oil pump of recent internal combustion engines is a variable displacement oil pump (VDOP), which can alternatively operate in an high displacement configuration or in a low displacement configuration. In fact, the low displacement configuration reduces the fuel consumption, while the high displacement configuration improves the engine protection.

The VDOP is controlled by an engine control unit (ECU), which switches it between the high displacement configuration and the low displacement configuration, based on the engine working point, namely based on the engine speed and the engine torque. More particularly, the ECU conventionally commands the VDOP in the high displacement configuration for high values of the engine speed and/or of the engine torque, while commands the VDOP in the low displacement configuration for low values of the engine speed and/or of the engine torque.

A side effect of this control strategy is therefore in that, if the engine speed and/or the engine torque steeply decrease, for example due to a toll barrier stop after a prolonged motorway operation, the VDOP is presently switched from the high displacement configuration to the low displacement configuration, despite the engine is still very hot. This switching causes a sudden drop of the lubricating oil flow rate through the engine, thereby causing an abrupt decrease of oil temperature and pressure in the main oil gallery, which leads to a worse operation of the internal combustion engine and which can even cause damages.

In order to solve this drawback, strategies have been proposed which provide for controlling the VDOP also based on the engine coolant temperature. However, the engine coolant temperature is loosely related to the oil temperature, such that these strategies generally are not much effective.

In view of the above, it is at least one object to solve the above-mentioned drawback, which is to avoid oil pressure dips and heat soaks when engine speed and torque are steeply decreased after an high engine power operation. At least another object is to optimize the management of a VDOP during engine transients, to achieve a better compromise between the fuel economy attained by the VDOP in low displacement configuration and the improved engine protection attained by the VDOP in high displacement configuration. In addition, other objects, desirable features, and characteristics will become apparent from the subsequent summary and detailed description, and the appended claims, taken in conjunction with the accompanying drawings and this background.

### SUMMARY

A method is provided for operating a variable displacement oil pump of an internal combustion engine, comprising measuring a value of an engine metal temperature, namely the temperature of a metallic component of the engine-case, such as for example the cylinder head or the cylinder block, and preventing the variable displacement oil pump to switch from an high displacement configuration to a low displacement configuration, as long as the measured value is greater than a first threshold value of the engine metal temperature. Since the engine metal temperature is tightly linked to the oil temperature and other oil properties, it provides a fine indication of the thermal status of the engine, so that the proposed strategy improves the VDOP control achieving a better thermal management of the engine during transients. In particular, even if the engine speed and torque are steeply decreased after a high engine power operation, the VDOP will be kept in the high displacement configuration, thereby advantageously avoiding oil pressure dips and heat soaks and therefore effectively protecting the engine. Another advantage is that a metal temperature sensor (MTS), which measures the above named engine metal temperature, is usually already mounted on most internal combustion engines for other purposes, so that no additional sensor and cost are required for implementing the proposed method.

According to an embodiment, the method comprises determining the said first threshold value of the engine metal temperature, and directly identifying whether the measured value of the engine metal temperature is greater than this first threshold value.

Alternatively, the method can provide for determining a first threshold value of a different engine parameter linked to the engine metal temperature, such as for example the oil temperature or pressure, using the measured value of the engine metal temperature for estimating a value of this engine parameter, and indirectly identifying that the measured value of the engine metal temperature is greater than the correlated first threshold value, if the estimated value of the engine parameter is greater than the first threshold value related thereto. In fact, the first solution has the advantage of requiring less computational effort when it is performed, while the second solution has the advantage of requiring less calibration effort for determining the threshold value.

According to another embodiment, the method comprises the further step of preventing the variable displacement oil pump to switch from the low displacement configuration to the high displacement configuration, as long as the measured value of the engine metal temperature is lower than a second threshold value of the engine metal temperature. This embodiment has the advantage of quickening the warm up of the internal combustion engine when it is cold. Also in this case, the method can provide for determining the second threshold value of the engine metal temperature and for directly identifying whether the measured value is lower than this second threshold value, or alternatively, the method can provide for determining a second threshold value of a different engine parameter linked to the engine metal temperature, such as for example the oil temperature or pressure, for using the measured value of the engine metal temperature in order to estimate a value of this engine parameter, and for indirectly identifying that the measured value of the engine metal temperature is lower than the correlated second threshold value, if the estimated value of the engine parameter is lower than the second threshold value related thereto.

According to still another embodiment, the first threshold value of the engine metal temperature is greater than the second threshold value of the engine metal temperature. The embodiment has the advantage of taking into account the thermal hysteresis of the internal combustion engine.

According to another embodiment, the method can be carried out with the help of a computer program comprising a program-code for carrying out all the steps of the method described above, and in the form of a computer program product comprising the computer program. The computer program can be transported by an electromagnetic signal, the signal being modulated to carry a sequence of data bits that represent a computer program to carry out all steps of the method. The computer program may reside on or in a data carrier, e.g., a flash memory, which is data connected with a control apparatus for an internal combustion engine. The control apparatus has a microprocessor that receives computer readable instructions in form of parts of said computer program and executes them. Executing these instructions amounts to performing the steps of the method as described above, either wholly or in part.

The electronic control apparatus can be a dedicated piece of hardware such as the ECU, which is commercially available and thus known in the art, or can be an apparatus different from such an ECU, e.g. an embedded controller. If the computer program is embodied as an electromagnetic signal as described above, then the ECA, e.g. the ECU, has a receiver for receiving such a signal or is connected to such a receiver placed elsewhere. The signal may be transmitted by a programming robot in a manufacturing plant. The bit sequence carried by the signal is then extracted by a demodulator connected to the storage unit, after which the bit sequence is stored on or in said storage unit of the ECA.

The electronic control apparatus can also be part of an internal combustion engine comprising a variable displacement oil pump, an engine control unit, a data carrier associated to the engine control unit and the computer program stored in the data carrier, so that, when the electronic control apparatus executes the computer program, all the steps of the method described above are carried out.

Another embodiment refers to an apparatus for operating a variable displacement oil pump of an internal combustion engine, the apparatus comprising means for measuring a value (EMT) of an engine metal temperature and means for preventing the variable displacement oil pump to switch from an high displacement configuration to a low displacement configuration, as long as the measured value (EMT) is greater than a first threshold value (T1) of the engine metal temperature. Since the engine metal temperature is tightly linked to the oil temperature and other oil properties, this apparatus provides a fine indication of the thermal status of the engine, so that the proposed apparatus improves the VDOP control achieving a better thermal management of the engine during transients. In particular, even if the engine speed and torque are steeply decreased after an high engine power operation, the VDOP will be kept in the high displacement configuration, thereby advantageously avoiding oil pressure dips and heat soaks and therefore effectively protecting the engine. Another advantage of this apparatus is that a metal temperature sensor (MTS), which measures the above named engine metal temperature, is usually already mounted on most internal combustion engines for other purposes, so that no additional sensor and cost are required for implementing the proposed method.

An embodiment of the apparatus further comprises means for determining this first threshold value (T1) of the engine metal temperature and means for identifying whether the measured value (EMT) of the engine metal temperature is greater than this first threshold value (T1). An alternative apparatus hereto comprises means for determining a first threshold value of a different engine parameter linked to the engine metal temperature, such as for example the oil temperature or pressure, means for using the measured value of the engine metal temperature for estimating a value of this engine parameter, and means for indirectly identifying that the measured value of the engine metal temperature is greater than the correlated first threshold value, if the estimated value of the engine parameter is greater than the first threshold value related thereto. In fact, the apparatus of the penultimate paragraph first has the advantage of requiring less computational effort when it is performed, while the alternative apparatus of the last paragraph has the advantage of requiring less calibration effort for determining the threshold value.

A further embodiment furthermore comprises means for preventing the variable displacement oil pump to switch from the low displacement configuration to the high displacement configuration, as long as the measured value (EMT) is lower than a second threshold value (T2) of the engine metal temperature. This choice has the advantage of quickening the warm up of the internal combustion engine when it is cold.

A further embodiment of the apparatus furthermore comprises means for determining this second threshold value (T2) of the engine metal temperature and means for identifying whether the measured value (EMT) of the engine metal temperature is lower than this second threshold value (T2). In the alternative, the apparatus further comprises means for determining a second threshold value (Th2) of an engine parameter linked to the engine metal temperature, means for using the measured value (EMT) of the engine metal temperature for estimating a value (EPV) of this engine parameter and means for identifying that the measured value (EMT) of the engine metal temperature is lower than the correlated second threshold value, if the estimated value (EPV) of the engine parameter is lower than the second threshold value (Th2) related thereto.

According to still another embodiment, the apparatus is configured to operate with a first threshold value of the engine metal temperature that is greater than the second threshold value of the engine metal temperature. This choice has the advantage of taking into account the thermal hysteresis of the internal combustion engine.

### BRIEF DESCRIPTION OF THE DRAWINGS

The present invention will hereinafter be described in conjunction with the following drawing figures, wherein like numerals denote like elements, and:

FIG. 1 is a schematic representation of an internal combustion engine;

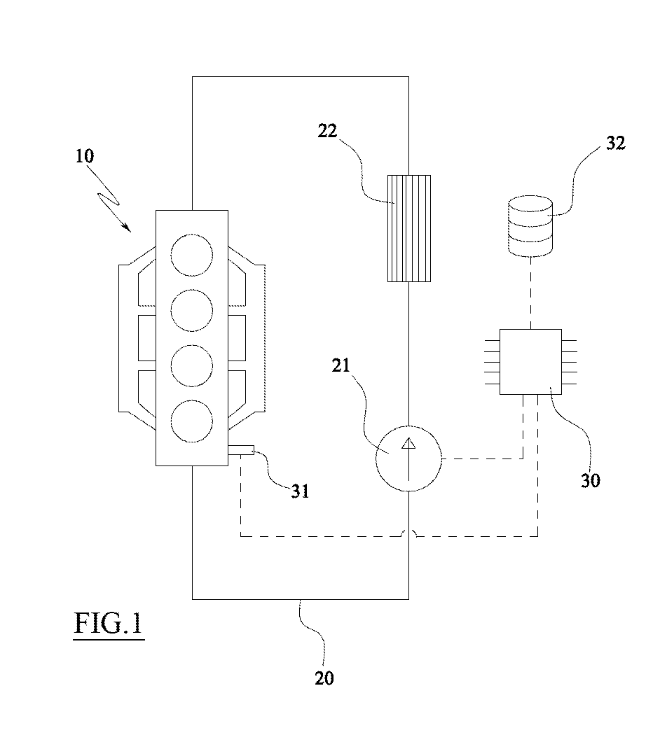

FIG. 2 is a flowchart of a method for operating a VDOP according to an embodiment; and

FIG. 3 is a flowchart of a method for operating a VDOP according to another embodiment.

### DETAILED DESCRIPTION

The following detailed description is merely exemplary in nature and is not intended to limit application and uses. Furthermore, there is no intention to be bound by any theory presented in the preceding background or summary or the following detailed description.

Two embodiments of the invention are hereinafter disclosed with reference to an internal combustion engine 10 of a motor vehicle, for instance a Diesel engine or a gasoline engine. The internal combustion engine 10 is equipped with a lubricating circuit 20, in which a lubricating oil is circulated so as to cool and lubricate the rotating or sliding components of the internal combustion engine 10. In fact, the lubricating circuit 20 schematically comprises an oil pump 21 driven by the engine 10, which draws lubricating oil from an oil sump, and which delivers this lubricating oil under pressure through a main oil gallery (not shown) realized in the cylinder block of the engine 10.

The main oil gallery is connected via respective pipes to a plurality of exit holes for lubricating crankshaft bearings (main bearings and big-end bearings), camshaft bearings operating the valves, tappets, and the like, from which the lubricating oil finally returns into the oil sump. A radiator 22 is usually located in the lubricating circuit 20 for cooling the lubricating oil, thereby maintain its temperature below a predetermined value. More particularly, the pump 21 is a variable displacement oil pump (VDOP), which can alternatively operate in a high displacement configuration or in a low displacement configuration.

In fact, for a given value of the engine speed, the VDOP 21 in the high displacement configuration is arranged for circulating a mass flow of lubricating oil which is greater than that circulated by the same VDOP 61 in low displacement configuration. As a consequence, the low displacement configuration allows to reduce the fuel consumption, because it decreases the power spent by engine for driving the VDOP, while the high displacement configuration allows to improve the engine protection.

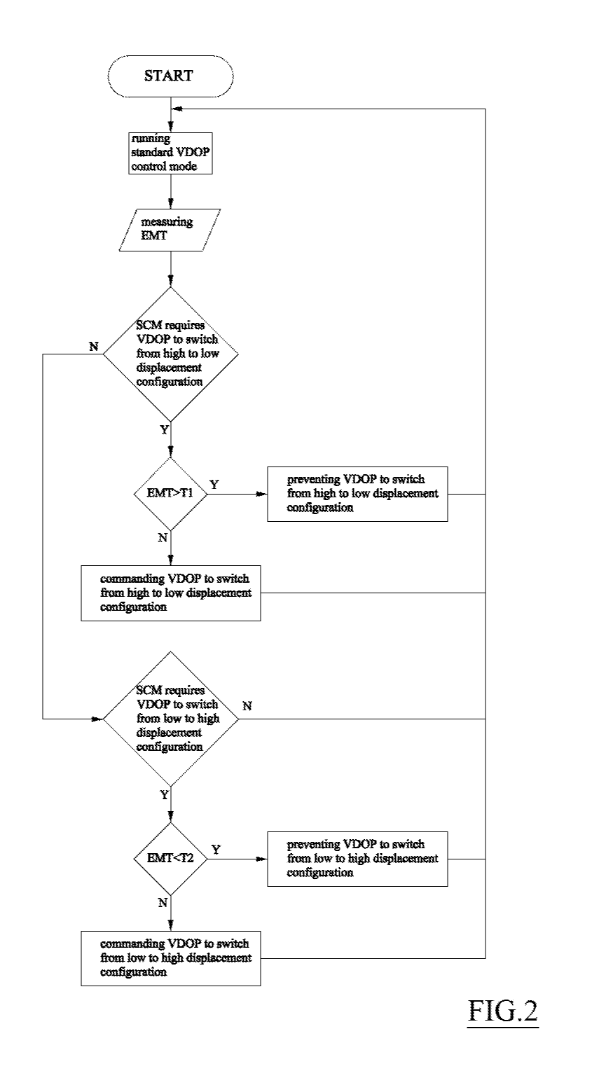

During the operation of the engine 10, the VDOP 21 is electrically controlled by an engine control unit (ECU) 30, which causes the VDOP 21 to switch between the high displacement configuration and the low displacement configuration, according to the strategy illustrated in the flowchart of FIG. 2. This strategy firstly provides for enabling a standard control mode (SCM) of the VDOP 21, which generally provides for controlling the VDOP 21 on the basis of the engine working point, namely on the basis of the engine speed and the engine torque. More particularly, the SCM generally comprises the steps of monitoring the engine speed and/or the engine torque during the operation of the internal combustion engine 10, of requiring the VDOP 21 to switch from the low displacement configuration to the high displacement configuration, once the monitored values of the engine speed and/or of the engine torque exceed respective first threshold values, and of requiring the VDOP 21 to switch from the high displacement configuration to the low displacement configuration, once the monitored values of the engine speed and/or of the engine torque fall below respective second threshold values. The above named first threshold values are usually a little greater than the related second threshold values, in order to take into account the thermal hysteresis of the engine 10.

As a matter of course, the SCM also provides for keeping the VDOP 61 in the high displacement configuration as long as the monitored values of the engine speed and/or of the engine torque are over the respective first threshold values, and analogously for keeping the VDOP 61 the low displacement configuration as long as the monitored values of the engine speed and/or of the engine torque are below the respective second threshold values. While the SCM is running, the VDOP operating strategy provides for monitoring also an engine metal temperature, namely the temperature of a metallic component of the engine-case, such as for example the cylinder head or the cylinder block. More precisely, the engine metal temperature is measured by means of an metal temperature sensor (MTS) 31, which is applied to the above named metallic component of the engine 10 and which is wired to the ECU 30.

If the SCM requires the VDOP 21 to switch from the high displacement configuration to the low displacement configuration, the VDOP operating strategy provides for checking whether the actual measured value EMT of the engine metal temperature is greater than a first threshold value T1 related thereto. The first threshold value T1 can be empirically determined during a calibration activity and then stored in a data carrier 32 connected with the ECU 30.

If the measured value EMT of the engine metal temperature is greater than the first threshold value T1, the strategy provides for preventing the VDOP 21 to switch from the high displacement configuration to the low displacement configuration in spite of the SCM requirement, thereby keeping the VDOP 21 in the high displacement configuration as long as the measured value EMT of the engine metal temperature is greater than the first threshold value T1. Only if (or once) the measured value EMT is not greater than the first threshold value T1, the strategy provides for actually commanding the VDOP 21 to switch from the high displacement configuration to the low displacement configuration. In fact, this command is effected by the ECU 30 that generates and applies to the VDOP 21 a specific electric switching signal.

Conversely, if the SCM requires the VDOP 21 to switch from the low displacement configuration to the high displacement configuration, the strategy provides for checking whether the actual measured value EMT of the engine metal temperature is lower than a second threshold value T2 related thereto. Also this second threshold value T2 can be empirically determined during a calibration activity and then stored in the data carrier 32 connected with the ECU 30. The second threshold value T2 is preferably a little lower than the first threshold value T1.

If the measured value EMT of the engine metal temperature is lower than the second threshold value T2, the strategy provides for preventing the VDOP 21 to switch from the low displacement configuration to the high displacement configuration in spite of the SCM requirement, thereby keeping the VDOP 21 in the low displacement configuration as long as the measured value EMT of the engine metal temperature is lower than the second threshold value T2. Only if (or once) the measured value EMT is not lower than the second threshold value T2, the operating method provides for actually commanding the VDOP 21 to switch from the low displacement configuration to the high displacement configuration. In fact, also this command is effected by the ECU 30 that generates and applies to the VDOP 21 a specific electric switching signal. In all the other operating cases, the VDOP 21 is conventionally controlled according to the SCM.

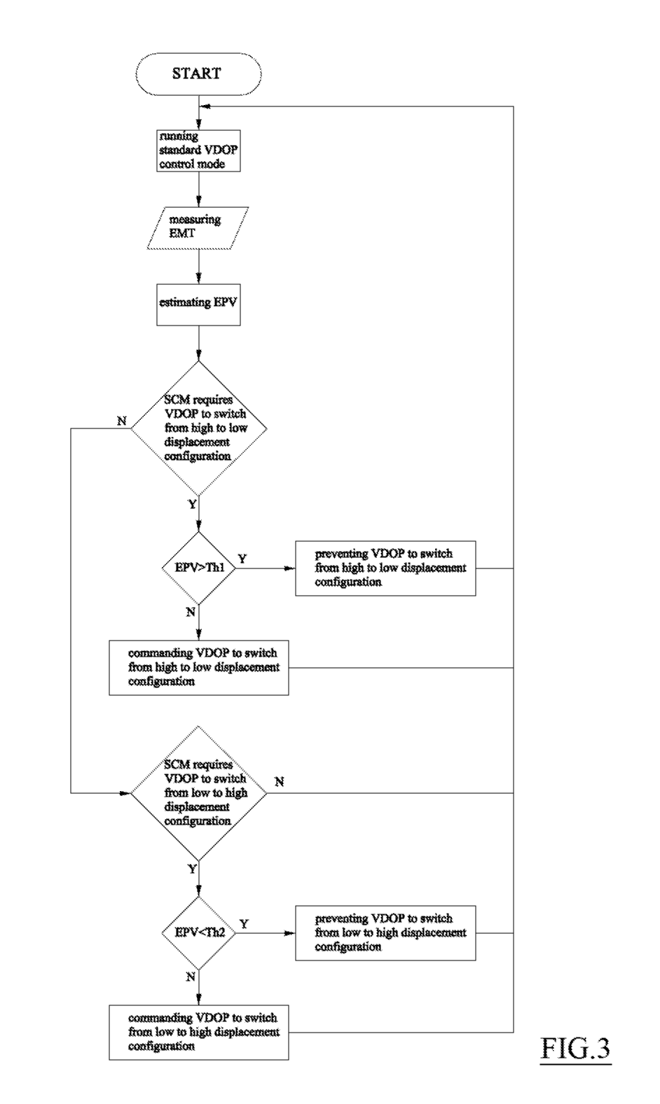

It should be noted that the operating method described above provides for directly comparing the measured value EMT of the engine metal temperature with the first and second threshold values T1 and T2 related thereto. However, it could be also possible to affect this comparison indirectly, as provided by the alternative VDOP operating strategy that is shown in FIG. 3.

This operating method comprises the same main steps of enabling the standard control mode (SCM) of the VDOP 21, and of monitoring the engine metal temperature, by means of the MTS 31, while the SCM is running. However, the measured value EMT of the engine metal temperature is here used for estimating a value EPV of a different engine parameter, which is proportionally linked to the engine metal temperature, such as for example the oil temperature or pressure. In this way, this engine parameter is monitored during the operation of the engine 10 as well as the engine metal temperature.

If the SCM requires the VDOP 21 to switch from the high displacement configuration to the low displacement configuration, the present strategy provides for checking whether the actual estimated value EPV of the above named engine parameter is greater than a first threshold value Th1 of this engine parameter. If the estimated value EPV of the engine parameter is greater than the first threshold value Th1, the strategy provides for preventing the VDOP 21 to switch from the high displacement configuration to the low displacement configuration in spite of the SCM requirement, thereby keeping the VDOP 21 in the high displacement configuration as long as the estimated value EPV of the engine parameter is greater than the first threshold value Th1. Only if (or once) the estimated value EMT is not greater than the first threshold value T1, the operating method provides for actually commanding the VDOP 21 to switch from the high displacement configuration to the low displacement configuration.

Conversely, if the SCM requires the VDOP 21 to switch from the low displacement configuration to the high displacement configuration, the present strategy provides for checking whether the actual estimated value EPV of the engine parameter is lower than a second threshold value Th2 of this engine parameter. If the estimated value EPV of the engine parameter is lower than the second threshold value Th2, the strategy provides for preventing the VDOP 21 to switch from the low displacement configuration to the high displacement configuration in spite of the SCM requirement, thereby keeping the VDOP 21 in the low displacement configuration as long as the estimated value EPV of the engine parameter is lower than the second threshold value Th2. Only if (or once) the estimated value EPV is not lower than the second threshold value Th2, the operating method provides for actually commanding the VDOP 21 to switch from the low displacement configuration to the high displacement configuration.

In all the other operating cases, the VDOP 21 is conventionally governed according to the SCM. Also for this operating method, the first threshold value Th1 and second threshold value Th2 can be empirically determined during a calibration activity and then stored in the data carrier 32 connected with the ECU 30. The second threshold value Th2 is preferably a little lower than the first threshold value Th1.

It should be noted that, being the above mentioned engine parameter proportionally linked to the engine metal temperature, the steps of identifying whether the estimated value EPV is over or below the first and the second threshold values Th1 and Th2, practically identify whether the measured value EMT is over or below the two values of the engine metal temperature that respectively correspond to the threshold values Th1 and Th2.

According to an embodiment, each of the VDOP operating strategies described above are preferably performed with the aid of a computer program, which comprises a computer-code for performing the method, and which is stored in the data carrier 32, so that, when the ECU 30 executes the computer program, all the steps of the method described above are carried out.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the forgoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and in their legal equivalents.

What is claimed is:

1. A method for operating a variable displacement oil pump of an internal combustion engine, comprising:
measuring a measured value of an engine metal temperature; and
preventing the variable displacement oil pump to switch from an high displacement configuration to a low displacement configuration as long as the measured value is greater than a first threshold value of the engine metal temperature.

2. The method according to claim 1, further comprising:
determining the first threshold value of the engine metal temperature; and
identifying whether the measured value of the engine metal temperature is greater than the first threshold value.

3. The method according to claim 1, further comprising:
determining the first threshold value of an engine parameter linked to the engine metal temperature;
using the measured value of the engine metal temperature for estimating an estimated value of the engine parameter; and
identifying that the measured value of the engine metal temperature is greater than the first threshold value, if the measured value of the engine parameter is greater than the first threshold value related thereto.

4. The method according to claim 1, further comprising preventing the variable displacement oil pump to switch from the low displacement configuration to the high displacement configuration, as long as the measured value is lower than a second threshold value of the engine metal temperature.

5. The method according to claim 4, further comprising:
determining the second threshold value of the engine metal temperature; and
identifying whether the measured value of the engine metal temperature is lower than the second threshold value.

6. The method according to claim 4, further comprising:
determining the second threshold value of an engine parameter linked to the engine metal temperature;
using the measured value of the engine metal temperature for estimating a value of the engine parameter; and
identifying that the measured value of the engine metal temperature is lower than the second threshold value, if the value of the engine parameter is lower than the second threshold value related thereto.

7. The method according to claim 4, wherein the first threshold value of the engine metal temperature is greater than the second threshold value of the engine metal temperature.

8. A computer readable medium embodying a computer program product, said computer program product comprising:
an operating program for operating a variable displacement oil pump of an internal combustion engine, the operating program configured to:
measure a measured value of an engine metal temperature; and
prevent the variable displacement oil pump to switch from an high displacement configuration to a low displacement configuration as long as the measured value is greater than a first threshold value of the engine metal temperature.

9. The computer readable medium embodying the computer program product according to claim 8, the operating program further configured to:
determine the first threshold value of the engine metal temperature; and
identify whether the measured value of the engine metal temperature is greater than the first threshold value.

10. The computer readable medium embodying the computer program product according to claim 8, the operating program further configured to:
determine the first threshold value of an engine parameter linked to the engine metal temperature;
use the measured value of the engine metal temperature for estimating a value of the engine parameter; and
identify that the measured value of the engine metal temperature is greater than the first threshold value, if the value of the engine parameter is greater than the first threshold value related thereto.

11. The computer readable medium embodying the computer program product according to claim 8, the operating program further configured to prevent the variable displacement oil pump to switch from the low displacement configuration to the high displacement configuration, as long as the measured value is lower than a second threshold value of the engine metal temperature.

12. The computer readable medium embodying the computer program product according to claim 11, the operating program further configured to:
determine the second threshold value of the engine metal temperature; and
identify whether the measured value of the engine metal temperature is lower than the second threshold value.

13. The computer readable medium embodying the computer program product according to claim 11, the operating program further configured to:
determine the second threshold value of an engine parameter linked to the engine metal temperature;
use the measured value of the engine metal temperature for estimating a value of the engine parameter; and
identify that the measured value of the engine metal temperature is lower than the second threshold value, if the value of the engine parameter is lower than the second threshold value related thereto.

14. The computer readable medium embodying a computer program product according to claim 11, wherein the first threshold value of the engine metal temperature is greater than the second threshold value of the engine metal temperature.

15. An internal combustion engine, comprising:
a variable displacement oil pump; and
an engine control unit configured to control the variable displacement oil pump, the engine control unit configured to:
measure a measured value of an engine metal temperature; and
prevent the variable displacement oil pump to switch from an high displacement configuration to a low displacement configuration as long as the measured value is greater than a first threshold value of the engine metal temperature.

16. The internal combustion engine according to claim 15, the engine control unit further configured to:
determine the first threshold value of the engine metal temperature; and
identify whether the measured value of the engine metal temperature is greater than the first threshold value.

17. The internal combustion engine according to claim 15, the engine control unit further configured to:
determine the first threshold value of an engine parameter linked to the engine metal temperature;
use the measured value of the engine metal temperature for estimating an estimated value of the engine parameter; and
identify that the measured value of the engine metal temperature is greater than the first threshold value, if the measured value of the engine parameter is greater than the first threshold value related thereto.

18. The internal combustion engine according to claim 15, the engine control unit further configured to prevent the variable displacement oil pump to switch from the low displacement configuration to the high displacement configuration, as long as the measured value is lower than a second threshold value of the engine metal temperature.

19. The internal combustion engine according to claim 18, the engine control unit further configured to:
determine the second threshold value of the engine metal temperature; and
identify whether the measured value of the engine metal temperature is lower than the second threshold value.

20. The internal combustion engine according to claim 17, the engine control unit further configured to:
determine a second threshold value of the engine parameter linked to the engine metal temperature;
use the measured value of the engine metal temperature for estimating a value of the engine parameter; and
identify that the measured value of the engine metal temperature is lower than the second threshold value, if the estimated value of the engine parameter is lower than the second threshold value related thereto.
